(19) United States
(12) Patent Application Publication
(10) Pub. No.: US 2025/0187787 A1
(43) Pub. Date: Jun. 12, 2025

(54) Collection Container with Invertible Multi-Directional Lift Access

(71) Applicant: JHM Enterprises LLC, Marietta, GA (US)

(72) Inventors: Jose A. Hernandez, Marietta, GA (US); Heather S. Miller, Marietta, GA (US); Robert M Heilbrun, Plano, TX (US); Jeffrey A. Garrett, Plano, TX (US); Suri Khanh Le, Plano, TX (US); Chih-wen Pan, Taipei City (TW)

(73) Assignee: JHM Enterprises, LLC, Marietta, GA (US)

(21) Appl. No.: 18/532,519

(22) Filed: Dec. 7, 2023

(51) Int. Cl. B65D 21/02; B65D 1/22; B65D 1/46; B65F 1/02

(52) U.S. Cl. CPC B65D 21/0212; B65D 1/22; B65D 1/46; B65F 1/02; B65F 2220/124; B65F 2250/11; B65F 2250/114

(57) ABSTRACT

An improved bin for receiving, storing or shipping goods, products or debris which has a horizontally-oriented bottom portion with at least two pairs of fork lift fork receiving channels, wherein each pair of fork lift fork receiving channels extends through the bottom portion, and wherein each fork lift fork receiving channel has a fork receiving port that is enclosed by a port top, two port sides and a port bottom; and at least one vertically-oriented wall disposed around a periphery of the bottom portion, thereby defining an open-top bin which allows for lifting the bin in an upright position using a forklift, and which allows for inverting the bin by rotating a forklift fork such that the a weight of the bin is supported by two or more of the port bottoms of the fork receiving ports. A self-spacing stacking feature is also available in some embodiments.

### FIELD OF THE INVENTION

The present invention relates to containers and bins for collection of debris, refuse, rubbish, recyclable materials, and in particular construction trash, and for storing or transporting bulk materials such as fresh produce (fruits, vegetables, etc.), textiles, and the like.

### BACKGROUND OF THE INVENTION

Collection, storage and transportation bins are widely used in both shipping and collection industries. Collection of trash, refuse, garbage, boxes, emptied packages, recyclable materials, and discarded construction materials may be regulated by local, regional and national requirements in order to reduce littering, environmental impact, and community quality of life issues. Storage and shipping of new good and produce can be performed in some containers which also can be used as a collection bin, although many collection bins which were designed for heavy loads incorporate specific features for emptying them which are not needed in a shipping or storage container.

### SUMMARY OF THE INVENTION

An improved bin for receiving, storing or shipping goods, products or debris is disclosed and illustrated which has a horizontally-oriented bottom portion with at least two pairs of fork lift fork receiving channels, wherein each pair of fork lift fork receiving channels extends through the bottom portion, and wherein each fork lift fork receiving channel has a fork receiving port that is enclosed by a port top, two port sides and a port bottom; and at least one vertically-oriented wall disposed around a periphery of the bottom portion, thereby defining an open-top bin which allows for lifting the bin in an upright position using a forklift, and which allows for inverting the bin by rotating a forklift fork such that the a weight of the bin is supported by two or more of the port bottoms of the fork receiving ports. A self-spacing stacking feature is also available in some embodiments.

### BRIEF DESCRIPTION OF DRAWINGS

The figures presented herein, when considered in light of this description, form a complete disclosure of one or more embodiments of the invention, wherein like reference numbers in the figures represent similar or same elements or steps.

FIG. 1 provides a perspective view of an example embodiment bin according to the present invention.

FIG. 2 provides a side view of an example embodiment bin according to the present invention.

FIG. 3 illustrates an exploded bottom view of an example embodiment bin according to the present invention.

FIG. 4 shows an assembled bottom view of an example embodiment bin according to the present invention.

FIG. 5 depicts a cut-away view with details of a bottom corner portion of an example embodiment bin according to the present invention.

FIG. 6 illustrates from a perspective top-down view of an embodiment variation according to the present invention which provides stacking separators and mounting provisions for tie-down D-rings.

FIG. 7 illustrates a perspective bottom-up view of the embodiment of FIG. 6.

FIG. 8 shows a view taken directly from a bottom of the embodiment of FIG. 6.

FIG. 9 shows a side view in which certain internal details are shown in heavy dashed lines.

### DETAILED DESCRIPTION

The present inventors have realized certain shortcomings and unmet needs in the fields of liftable containers for collection, storage and shipping of goods, including discarded goods and new goods, and in particular for containers for collection refuse from construction sites. While the following example embodiments of the present invention will be disclosed relative to a collection bin for construction sites, it will be recognized by those skilled that such collection bins may be used for a variety of other purposes within the spirit and scope of the present invention.

Constructions sites often produce a wide variety of trash and refuse, including sheet materials (e.g., plastic wrappers, insulation paneling, boxes, etc.) that can blow and drift away from the site into other nearby properties, streams, lakes, and roadways, thereby creating environmental and transportation hazards. These materials must be collected in containers which prevent them from blowing out of the container, which the present inventors have recognized as a first objective of the present invention. Other materials are larger and heavier, and therefore less likely to blow away from the construction site, such as scrap lumber, piping, tubes, shingles, buckets, plywood, etc., which are heavy when accumulated into a single place, such as a pile or container. The present inventors have recognized this as a second objective of the present invention. Still other materials are small and heavy, also less likely to blow away, such as nails, screws, pieces of cut tile, shards of bricks, etc., which must be collected into containers that do not allow them to fall out and cause hazards to tires, workers or visitors such as customers, code inspectors, etc. The present inventors have recognized this as a third objective of the present invention. Further, construction sites in particular tend to generate a lot of refuse in a short period of time, such as when the roofing crew is installing the new roof, and then tend to produce little or no trash for periods of time between phases of construction. The present inventors have recognized this as a fourth objective of the present invention.

Trash collection bins known in the art, including other containers originally intended for storage or shipping of goods, do not meet these or other objectives, the present inventors have determined. While some have lids, they may not be able to handle a large volume of material to allow for less frequent truck collections of their contents, and may not be able to handle the weight of heavier materials such as lumber, bricks, tile, and roofing. Others may have the strength and rigidity to handle a large volume and heavy weight, but they may not have lids to contain the lighter refuse from blowing away, or the lids may be so light that they blow open themselves.

For these and other reasons, the present inventors have developed a collection container specifically designed to meet most or all of these objectives in a single unit. Lid components are designed to remain closed, the structure of the collection container is strong enough to handle the expected weight of construction refuse, the volume of the container is large enough to allow collection trucks to maintain an economically feasible collection schedule between pick ups, and the base of the container is designed to improve the collection method and operations with minimized manual operations and minimized spillage during emptying into a collection truck.

### Invertible Bin.

The present disclosure relates to the specific feature of a new container bin that allows it to be raised and inverted by a machine such as a forklift which can invert the load on the forks when the container has been positioned over a collection vehicle such as a dump truck. The new base design, in at least one available embodiment, allows for the forks to enter under the container from any side (all four sides), thereby allowing quicker collection operations and reducing maneuvers required by the forklift operator to complete the collection process. Still further, the new base design provides sufficiently strong structures such that the base and the walls of the container are capable of holding the expected weight of the contents as the container is rotated from vertical to horizontal and the contents shift their weight from the bottom of the container to a side wall of the container, during the inversion process.

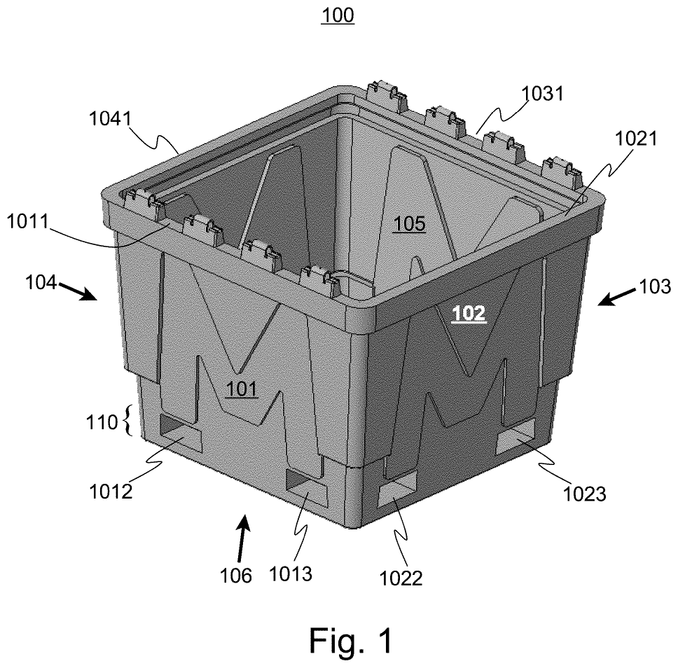

Referring now to FIG. 1, an example embodiment according to the present invention of a collection bin 100 is shown in perspective view, having four vertical sides 101, 102, 103 and 104, and a bottom 106, with an open top to define an interior containment space 105. Upper wall edges 1011, 1021, 1031 and 1041 may be provided with a reinforcement structure, such one or more rolls or corners, thereby providing a rigid rectangular rim without requiring a separate frame, such as a metal frame. The bin 100 may be constructed of a variety of materials, preferably sheet plastic, but also aluminum, steel and fiberglass in some other embodiments. Some of the upper wall edges may be provided with one or more hinge portions for receiving one or more hinged top components.

The base portion 110 of the bin is provided, in this example embodiment according to the present invention, with a first set of fork ports 1012, 1013, which provide a first set of channels from a first side 101 through the base towards the opposite side 103, and a second set of fork ports 1022, 1023 which provide a second set of channels from a third side 102 through the base towards the other opposite side 104, wherein the first set of channels and the second set of channels are essentially orthogonal to each other in a horizontal plane relative to the wall orientation. This allow a forklift to engage and lift the bin 100 from any direction approaching any of the four sides 101, 102, 103 and 104.

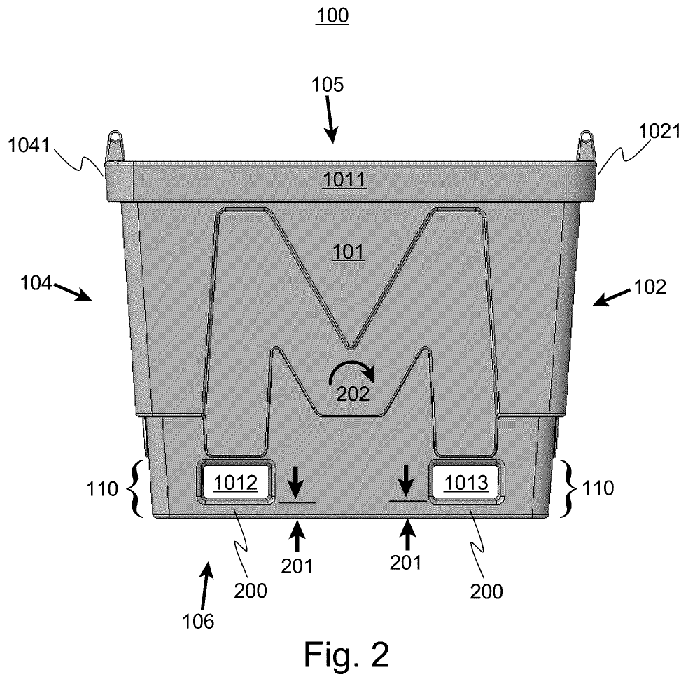

Turning to FIG. 2, a view from the first side 101 is shown for better view of the first pair of fork ports 1012 and 1013 into which a forklift's forks may enter the base portion 110. In this particular view, one can see that the base portion 110 is provided with fork ports which are closed by a bottom segment 200 of each fork port. The fork port bottom segments 200 of sufficient strength to allow a fully loaded bin to be lifted by a forklift, and then the forks on the forklift are rotated 202 about an axis running parallel to the forks to invert the bin and empty it over a collection truck. During the rotation 202, the collection bin 101 supports the weight of the contents on the bottom, then on the bottom and a side wall, and then, for a period of time, entirely on the side wall. When the bin reaches a fully inverted position, the fork port bottom segments 200 support the entire weight of the emptied collection bin 100.

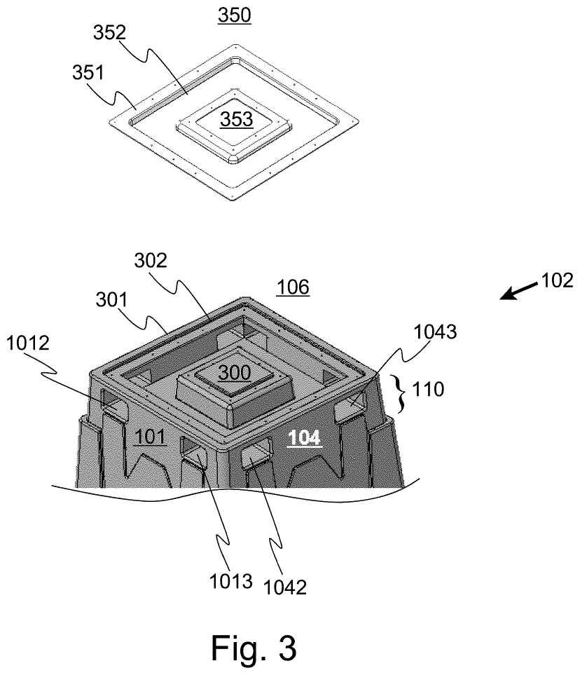

FIG. 3 shows a bottom portion 110 of the bottom 106 of the example embodiment according to the present invention in an inverted position. In this particular embodiment, the first set of first pair of fork ports 1012 and 1013 and the second pair of fork ports 1042 and 1043 are visible, and the interior of the channels to the opposite sides are visible. Also in this particular embodiment, a support island 300 is shown which not only helps to delineate the channels to guide the entering forks to the fork ports on the other side, it also provides mechanical support for the weight of the contents to be transmitted (when not inverted) to a reinforcement plate 350.

The example embodiment of the reinforcement plate has a rim 351 which is received and fastened into a recess 302 around the periphery 301 of the bottom portion 110. The reinforcement plate 350 also includes a support island receiver 353 which receives and captures the support island 300, and is fastened to it. The recessed or embossed portion 352 of the reinforcement plate is received into fork channels to provide a fourth wall (bottom wall when in normal position, top wall when inverted) to the fork channels such that, when inverted, the reinforcement plate may engage the forks and provide mechanical load support to the inverted collection bin 100. When the collection bin is in its normal upright position, the weight of the contents in the middle of the floor of the bin are transmitted through the support island 300 to the reinforcement plate 350, which then distributes some of the force to the periphery 301, 302 of the bottom portion 100, thereby reducing sag of the floor of the loaded collection bin and retaining the rectangular shape of the bottom portion 110.

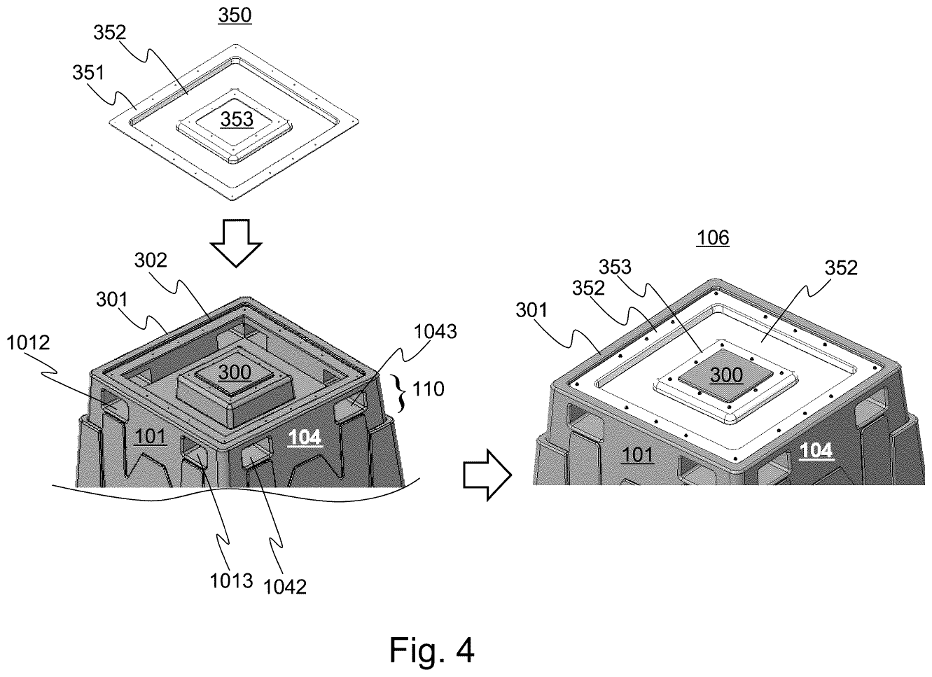

The reinforcement plate 350 is assembled to the bottom portion 110 as shown in FIG. 4 using suitable fasteners, such as but not limited to rivets, bolts, adhesive, and welding, thereby closing the two sets of channels for receiving the forks of a forklift or other suitable lifting machine (pallet jack, etc.).

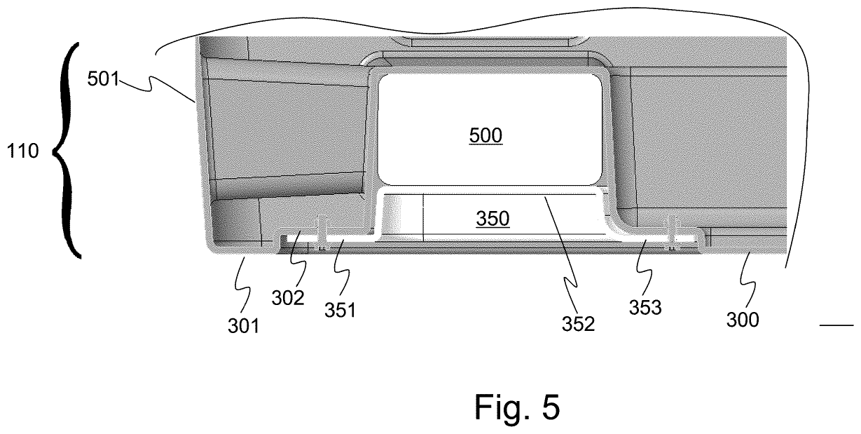

FIG. 5 shows a cut-away view of a bottom corner of the example embodiment collection bin 100 in which the mechanical cooperation between the bin side wall 501 and the bin bottom features 300, 301, 302, and the reinforcement plate features 350, 351, 352, 353 provide closed fork lift fork receiving channels 500 with continuous mechanical load bearing support during upright positioning (normal position), during rotating, and during inverted (upside down) positions.

### Frameless Sheet-Formed Bin.

As can be seen from these figures, especially with attention to FIG. 5, the plurality of folds, bends and corners in the sheet material provide strength and rigidity sufficient enough to allow exclusion of use of a strengthening frame of any sort. As such, a sheet material such as formed plastic can be used to fabricate a collection, storage and shipping bin according to the present invention, thereby providing continuous open-top enclosure which will not allow small debris (nails, screws, brick shards, pieces of tile, etc.) to fall out, which is strong enough to hold larger and heaver debris (lumber, shingles, etc.), and which provides for optional attachment of a lid to contain lighter debris (plastic, wrappers, boxes, etc.) from blowing out.

### Self-Spacing Stacking Feature.

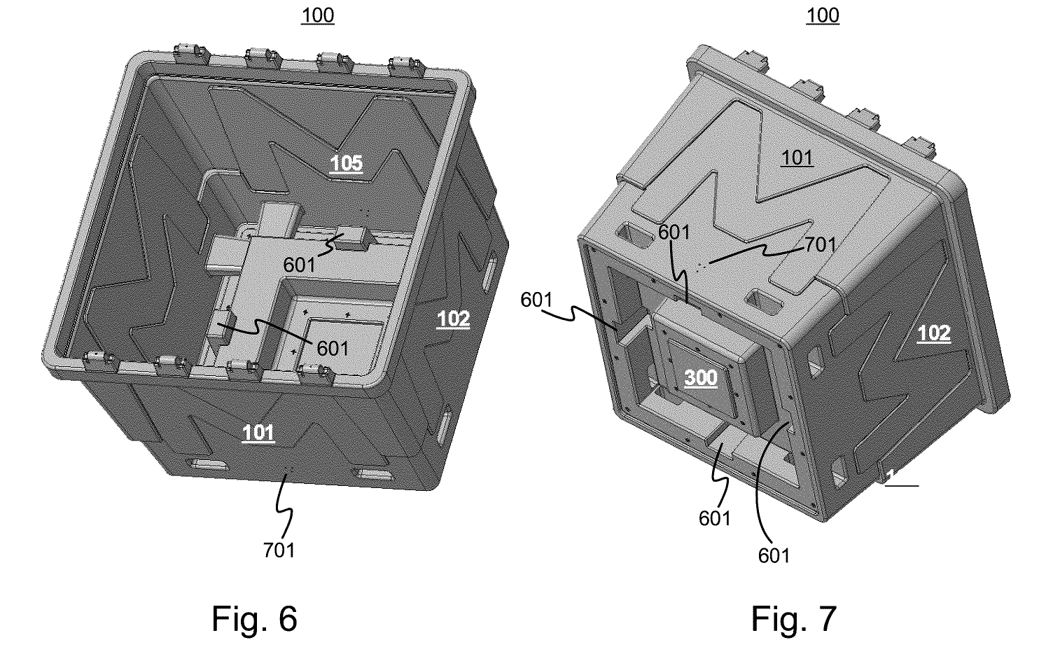

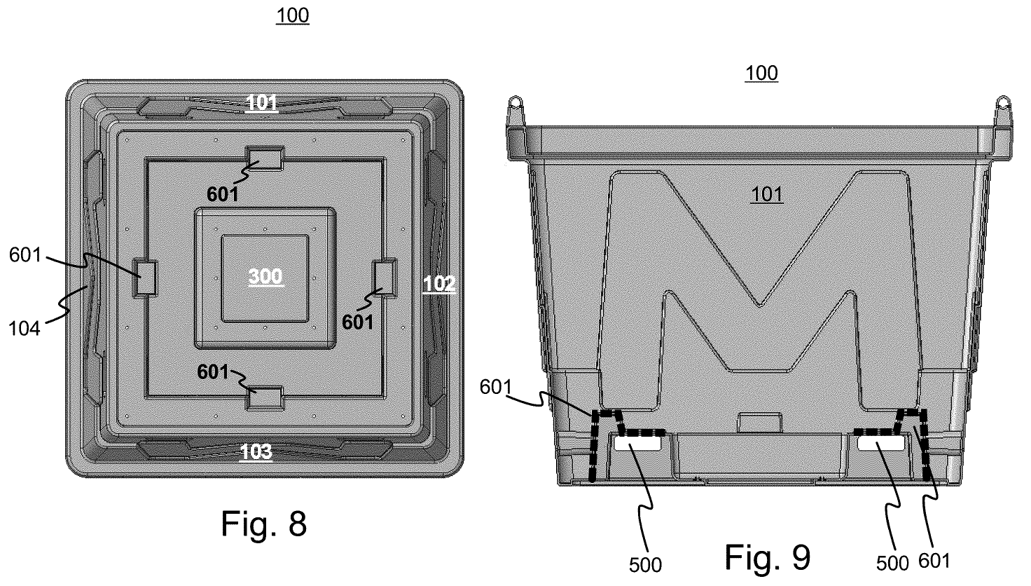

Referring now to FIGS. 6, 7, 8 and 9 show perspective top-down, perspective bottom-up, direct bottom and partially-transparent side views, respectively, of an embodiment variation with self-spacing stacking separators 601 is shown. Such stacking separators will allow a stack of similar units to be easily separated without concern for a vacuum or air lock developing between units. The one or more stacking separators 601 are generally upwardly protruding areas or portions which a second bin of like design and construction will rest upon when the second bin is stacked into and nested into the lower bin. This provides for an air gap between the stacked bins to prevent them from being vacuum locked into each other to promote easier unstacking of the bins. FIG. 9 shows the internal details using a heavy dashed lines of this example embodiment of self-spacing stacking seperators. These stacking separators 601 may be provided as molding features, or as separate devices that are attached to the top surface of the bottom of the bins, to the bottom surface of the bottom of the bins, to the sides of the bins, or a combination of methods. The separators in this example will actually work well in both orientations in which the bins are stacked with the tops facing up (normal) or with the tops facing down (inverted stack).

### Tie-Down Features.

Also shown in FIGS. 6 and 7 are mounting holes 701 for receiving and attaching one or more D-rings to which elastic tie downs maybe attached to hold the optional one or more hinged top components.lid portions in a closed position or an open position.

### Shapes, Dimensions, Materials and Proportions.

While a relatively square or cubic shape of the example embodiment has been shown and described, other shapes, dimensions and proportions are possible within the spirit and scope of the present invention. For example, a rectangular or even round shape is possible in some embodiments. As previously mentioned, bins according to the present invention may be constructed of a variety of materials, preferably sheet plastic, but also aluminum, wood, fiberboard, steel and fiberglass in some other embodiments.

As those skilled in the art will appreciate, the present invention may be embodied with many different shapes, ratios, angles, and dimensions. While the drawings provided herein show example embodiments, not necessarily to a particular scale, the intended method of transporation (fork lift, flat bed truck, train, intermodal shipping container, etc.), the intended material to be collected (general trash, fruits and produce, manufactured products, etc.) and the intended method of emptying are all factors in selecting a final shape, materials and dimensions.

In the present example embodiment which is sized appropriately for collection of construction debris and for transportation on the backs of flat bed trucks in empty stacks, and based on the strength of one particular sheet plastic material for fabrication, the bin is 65″ wide and 65″ (e.g., square in horizontal cross section) and 50″ tall (deep). The aforementioned example threaded inserts for receiving bolts are molded into the plastic material at the appropriate points and positions, and the leaves on the hinges for the top panels are riveted. However, many other embodiments are comprehended within the scope of the present invention for the variety of other uses, fabrication materials, and fastining requirements.

### CONCLUSION

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof, unless specifically stated otherwise.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

I/We claim:

1. A self-spacing stacking bin for receiving, storing or shipping goods, products or debris, comprising:
a horizontally-oriented bottom portion of a bin; and
at least one generally upwardly protruding stacking device which rises above any other vertical features of the bottom portion such that, when a second bin of similar shape and construction to a first bin is received into the first bin, a bottom portion of the second bin will contact and rest upon the at least one self-spacing stacking device.

2. The self-spacing stacking bin of claim 1 wherein the bottom portion further comprises a support island which extends upwardly with a height less than a height of the at least one self-spacing stacking device.

3. The self-spacing stacking bin of claim 2 wherein at least part of the stacking device extends from the support island.

4. The self-spacing stacking bin of 2 further comprising a reinforcement plate affixed to the support island to strengthen the bottom portion from sagging under load.

5. The self-spacing stacking bin of claim 4 wherein the reinforcement plate is further affixed to at least two edges of the bottom portion or to at least two wall portions of the first bin.

6. The self-spacing stacking bin of claim 1 wherein the at least one stacking device consists of four upwardly protruding stacking devices.

7. A method of manufacturing a bin for receiving, storing or shipping goods, products or debris, the method comprising forming a sheet of material to yield bottom portion of a big, wherein the bottom portion is horizontally-oriented, and wherein the forming comprises providing at least one generally upwardly protruding stacking device which rises above any other vertical features of the bottom portion such that, when a second bin of similar shape and construction to a first bin is received into the first bin, a bottom portion of the second bin will contact and rest upon the at least one self-spacing stacking device.

8. The method of manufacturing as set forth in claim 7 wherein the sheet material comprises a plastic sheet material.

9. The method of manufacturing as set forth in claim 7 wherein the sheet material comprises a metal sheet material.

10. The method of manufacturing as set forth in claim 7 wherein the sheet material comprises a fiberglass sheet material.
